(19) United States
(12) Patent Application Publication
(10) Pub. No.: US 2004/0019434 A1
(43) Pub. Date: Jan. 29, 2004

(54) Method and system for individual cattlem management

(75) Inventors: Luis O. Tedeschi, Ithaca, NY (US); Danny G. Fox, King Ferry, NY (US); Michael J. Baker, Livonia, NY (US)

Correspondence Address: PERKINS, SMITH & COHEN LLP, ONE BEACON STREET, 30TH FLOOR, BOSTON, MA, 02108, US

(73) Assignee: Cornell Research Foundation, Inc.

(21) Appl. No.: 10/621,082

(22) Filed: Jul. 16, 2003

Related U.S. Application Data
(60) Provisional application No. 60/396,361, filed on Jul. 17, 2002.

(51) Int. Cl. G06F 17/60; G06F 19/00; G01N 33/48; G01N 33/50

(52) U.S. Cl. 702/20; 705/1

(57) ABSTRACT

A computerized system and method that predicts individual steer or heifer feed requirements to compute daily or end of period cost of weight gain, feed efficiency, and carcass composition and to allocate feed fed to a pen of animals to the individuals in that pen on a biological basis, considering differences known to affect requirements (breed type, body size, stage and rate of growth). The method includes predicting the daily feed requirement and feed efficiency (or feed conversion) for an individual animal taking into account genotype, stage of growth and environmental differences, and predicting substantially optimum number of days to achieve finished weight final results and daily weight gain for the individual animal taking into account genotype and environmental differences.

### CROSS REFERENCE TO RELATED APPLICATIONS

This application claims priority of U.S. Provisional Application No. 60/396,361 entitled “Computer Model for Individual Cattle Management,” filed on Jul. 17, 2002, which is incorporated by reference herein.

### BACKGROUND OF THE INVENTION

This invention relates generally to the management of cattle to perform genetic selection for feed efficiency (or feed conversion), to obtain optimum beef quality while achieving improved profitability, and, more particularly, to a method and system for management of individual animals in a feedlot.

A feedlot is a place where cattle producers, such as ranchers, can send their weaned calves to have them finished for market in group pens on a cost of gain basis before shipment to a meat packer for slaughter. Feedlots generally feed and care for thousands of head of cattle at once in various stages of growth in pens of 100 head or more. These animals come from a variety of sources and differ in breed, body composition, and growth potential.

The average steer in the U.S. is approximately 1170 lb. when marketed, with approximately 50% grading choice. The effects of growth rate and feed efficiency for this average steer on cost to gain 600 lb. (570 lb. initial weight to 1170 lb. at low choice grade) has been studied by simulations. The results of the simulations show that a 10% improvement in rate of gain alone, as the result of a 7% increase in appetite, can improve profits 18%, primarily as the result of fewer days on feed and thus less non feed costs. The reduction in feed cost results from a reduction in feed required for maintenance due to fewer days required to gain 600 lb. Feed costs represent 60% of the total cost incurred in the feeding of cattle. Simulations have shown that a 10% improvement in feed efficiency can result in a 43% improvement in feedlot profit.

If differences in individual feed efficiency can be detected economically, this information has the potential to be used in the development of selection indexes. It is cost prohibitive to measure feed consumption on an individual animal basis in feedlots where most animals are evaluated. There is a need for methods that can accurately allocate feed to individuals fed in group pens.

Because of the wide variations in breed types and their crosses used for beef production in North America and environments in which they are fed prior to marketing as finished beef, there is a need for methods that predict feed requirements and cost of gain and account for differences in basal maintenance requirement, the effect of environment on maintenance requirement, the effect of mature body size, implant program and feeding system on finished weight and growth requirements, feed energy values, and dry matter consumption.

During most post-weaning growth programs (progeny tests in feedlots; bull tests) calves are fed for either a fixed period of time (bull and heifer tests; commodity fed in commercial feedlots) or until finished (individual cattle management systems; ICMS). For example, a calf fed post weaning from 500 lb to a 28% fat weight of 1200 lb had a mean body weight of 850 lb (71% of 28% fat weight), while another calf fed from 700 to a 28% fat weight of 1200 lb had mean body weight of 950 lb (79% of 28% fat weight). The expected feed required for the second calf would reflect an average higher fat content of the gain because of being further along the growth curve when started. Therefore adjustments are needed to be able to compare their feed requirements over the same stage of growth. There is a need for methods that allow comparison of feed requirements taking into account individual differences at the same stage of growth (same body composition).

It is therefore an object of this invention to provide methods for cattle management that can accurately allocate feed to individual animals fed in group pens, and to estimate their feed efficiency at the same stage of growth.

It is a further object of this invention to provide methods for cattle management that predict feed requirements and cost of gain and account for differences in basal maintenance requirement, the effect of environment on maintenance requirement, the effect of mature body size, implant program and feeding system on composition during growth, finished weight and growth requirements, feed energy values, and dry matter consumption.

It is still another object of this invention to provide methods for cattle management that allow comparison of feed requirements, feed efficiency among individual animals fed in group pens, and use the ranking analysis of the predicted feed efficiency of the progenies to perform genetic selection of the bulls.

### BRIEF SUMMARY OF THE INVENTION

The objects set forth above as well as further and other objects and advantages of the present invention are achieved by the embodiments of the invention described below.

A computerized system and method that predicts individual steer or heifer feeding requirements to compute daily or end of period cost of weight gain, feed efficiency (or feed conversion), and carcass composition and to allocate feed fed to a pen of animals to the individual steer or heifer in that pen on a biological basis, considering differences known to affect requirements (breed type, body size, stage and rate of growth) is disclosed. The method includes predicting the daily and accumulated live weight gain, feed requirement and cost, and body composition for an individual steer or heifer taking into account diet, genotype and environmental differences.

End of growth period or post harvest, feed can be allocated based on prediction of final EBF from carcass measures. The method is used to market cattle on an individual basis at the optimum harvest time, considering incremental cost of gain and carcass weight and composition discounts. The method is also used to compute variables used to select for feed efficiency that accounts for differences in body size and rate and composition of gain.

Specifically, the method of this invention predicts the following for each animal in a pen (feedlot steers or heifers, or herd replacement bulls or heifers) and provides this information in reports:

1. For each day, feed intake, animal performance, accumulated weight, and body composition are predicted,

2. Carcass measures taken on the live animal or carcass are used to predict carcass grade, composition of gain and expected finished weight,

3. At the end of each specified period of growth, average daily gain and accumulated weight, feed required, carcass composition, feed efficiency, cost of gain and profits are predicted,

4. Variables are computed for use in selecting for feed efficiency, as follows:

a) The weights within a non-specific range of maturity degree; usually 70 to 100% of 28% EBF weight (AFBW) is used;

b) Predicted feed intake in the method is adjusted until predicted and observed ADG match. Then, expected ADG (kg/d), predicted feed intake (kg/d), and mean shrunk body weight (kg) of that range of maturity degree is computed;

c) Feed conversion for that period is computed as (feed for maintenance+feed for gain)/ADG for that range of maturity degree. Feed efficiency is the inverse of feed conversion (1/feed efficiency).

d) Relative growth rate (ADG/SBW^{0.75}) is computed as adjusted for that range of maturity degree and expressed as g/kg^{0.75}/d

5. Actual accumulated feed fed to a pen is allocated to each individual, based on their proportional share computed from items 1 to 3 above.

For a better understanding of the present invention, together with other and further objects thereof, reference is made to the accompanying drawings and detailed description and its scope will be pointed out in the appended claims.

### BRIEF DESCRIPTION OF THE SEVERAL VIEWS OF THE DRAWING

FIG. 1a depicts a flowchart of an embodiment of the method of this invention;

FIG. 1b depicts a block diagram representation of an embodiment of the method of this invention;

FIG. 2 depicts a flowchart of an embodiment of the method of this invention for obtaining the daily feed requirement for an individual animal;

FIG. 3 is a graphical schematic representation of results from an embodiment of the method of this invention; and

FIG. 4 depicts a block diagram representative of an embodiment of the system of this invention.

### DETAILED DESCRIPTION OF THE INVENTION

In order to better understand the present invention described below, the following acronyms are defined below.

GLOSSARY

| | |
|---|---|
| ADG | Shrunk weight average daily gain, kg/d |
| AFBW | Final shrunk body weight adjusted to 28% fat |
| BRY | Boneless retail yield |
| BW | Body weight, kg |
| CF | Carcass fat, % |
| CW | Carcass weight, kg |
| CWP | Predicted carcass weight proportion, kg/kg |
| EBF | Empty body fat, % of EBW |
| EBG | Empty body gain, and is 0.956 ADG, kg/d |
| EBW | Empty body weight, and is 0.891 SBW, kg/d |
| EQSW | Equivalent shrunk weight, kg |
| EQCW | Equivalent carcass weight, kg |
| EQEBW | Equivalent empty body weight, kg |
| FFG | Feed for gain, kg/d |
| FFM | Feed for maintenance, kg/d |
| FSBW | Final shrunk body weight, kg |
| FT | Fat thickness, cm |
| FTU | FT predicted with ultrasound, cm |
| LM | Longissimus muscle, kg |
| LMA | Longissimus muscle area, cm² |
| LMAKG | Longissimus muscle area/(FSBW/100), cm²/kg |
| LMAU | LMA predicted with ultrasound, cm² |
| NEg | Net energy for gain, Mcal/d or Mcal/kg |
| NEm | Net energy for maintenance, Mcal/d or Mcal/kg |
| NEFG | Net energy available for gain, Mcal/d |
| RE | Retained energy, Mcal/d |
| SBW | Shrunk body weight, and is 0.96 full BW, kg |
| YG | Yield grade |

The term “genotype” as used herein includes breed type, body size, stage and rate of growth.

The term “animal” as used herein refers to feedlot steers or heifers, or herd replacement bulls or heifers.

A computerized system and method that predicts individual steer or heifer feeding requirements to compute daily or end of period cost of weight gain, feed efficiency, and carcass composition and to allocate feed fed to a pen of cattle to the individuals in that pen on a biological basis, considering differences known to affect requirements (breed type, body size, stage and rate of growth) is disclosed below.

The method of this invention includes predicting the daily and accumulated growth rate, feed requirement and cost, and body composition for an individual animal taking into account genotype, diet, and environmental differences.

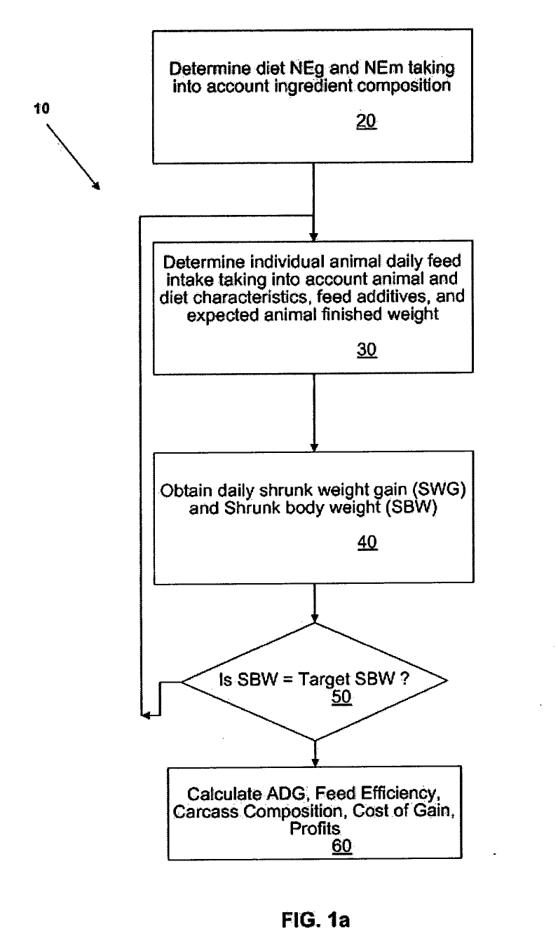

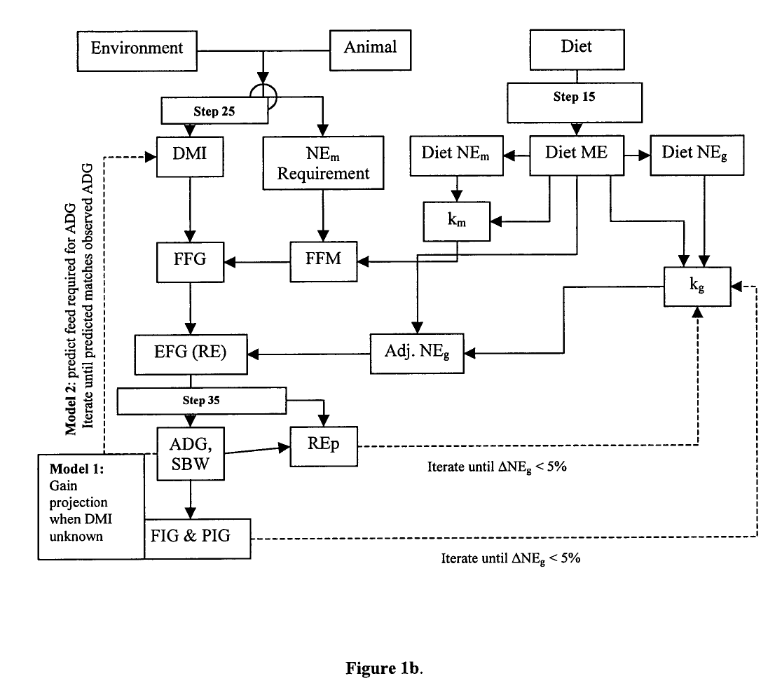

FIG. 1a depicts a flowchart of an embodiment of the method of this invention. A block diagram of an embodiment of the method of this invention, which graphically describes two types of predictions enabled by this embodiment, are shown in FIG. 1b. Referring to FIGS. 1a, 1b, net energy for gain, NEg, and net energy for maintenance, NEm, concentration of the diet are determined taking into account genotype and environmental differences (step 20, FIG. 1a; step 15, FIG. 1b). Environmental differences include variables such as outside temperature, internal and external insulation, wind, and hair coat depth and condition as well as activity. In one embodiment, the net energy for gain, NEg, and Net energy for maintenance, NEm, concentration of the diet are determined utilizing the Cornell Net Carbohydrate and Protein System (CNCPS) (see Fox, D. G., T. P. Tylutki, M. E. Van Amburgh, L. E. Chase, A. N. Pell, T. R. Overton, L. O. Tedeschi, C. N. Rasmussen, and V. M. Durbal, The Net Carbohydrate and Protein System for evaluating herd nutrition and nutrient excretion: Model documentation. Version 5.0, Mimeo No. 213, Animal Science Dept., Cornell University, Ithaca, N.Y., 2003). Referring again to FIGS. 1a, 1b, when daily gain is not known (Model 1, FIG. 1b), the daily feed intake is predicted for an individual animal taking into account diet net energy content, animal genotype, predicted animal finished weight at the target body fat and environmental differences (step 30, FIG. 1a; Step 25, Model 1, FIG. 1b). Then, the daily shrunk weight gain (SWG), and shrunk body weight (SBW) are obtained (Step 40, FIG. 1a; Step 35, FIG. 1b). The accumulated shrunk body weight (SBW) is compared to the target SBW (Step 50, FIG. 1a). If the shrunk body weight (SBW) is less than the target SBW, steps 30 and 40 of FIG. 1a (Steps 25 and 35 of FIG. 1b) are repeated. In one embodiment (FIG. 1b, Model 2), the method of this invention also includes the step of determining feed required for the observed ADG by adjusting the predicted daily feed requirement until predicted daily gain equals observed daily gain. It should be noted that in the embodiment shown in FIG. 1, the daily prediction is continued until optimum finished weight is reached. At the end of each specified period of growth, average daily gain and accumulated weight, days to finish, feed required, carcass composition and weight, feed efficiency, cost of gain and profits are predicted.

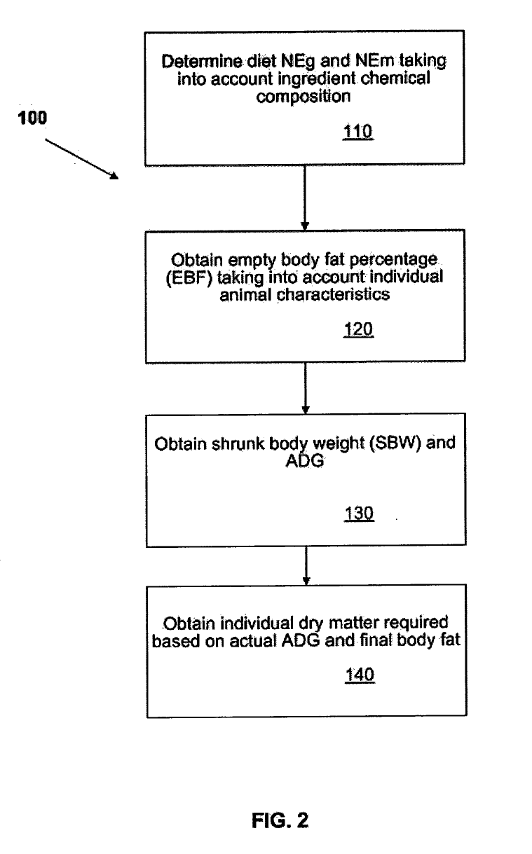

A flowchart of an embodiment of the method of this invention for obtaining the daily feed requirement for an individual animal based on actual BW, ADG and carcass measurements is shown in FIG. 2. Referring to FIG. 2, the net energy for gain (NEg) and Net energy for maintenance (NEm) concentration of the diet are determined taking into account diet ingredient chemical analysis and feed additives (step 110, FIG. 2). Next, an empty body fat percentage (EBF) is obtained taking into account individual animal characteristics (step 120, FIG. 2). In one embodiment, the empty body fat percentage is given by

EBF, %=17.76207+4.68142FT+0.01945HCW+0.81855QG−0.06754LMA

where FT=fat thickness (cm); HCW=hot carcass weight; QG=quality grade; LMA=Longissimus dorsi muscle area (cm²). An adjusted shrunk body weight is then calculated (step 130, FIG. 2). Then, an individual dry matter required is obtained (step 140, FIG. 2). In one embodiment, an adjusted individual dry matter required is obtained by multiplying the calculated individual dry matter required by the ratio of the total actual pen (group) dry matter consumed to the total pen (group) dry matter required (not shown).

In order to even more clearly understand the present invention, reference is now made to the following illustrative embodiment.

The system of equations utilized in this embodiment to predict individual animal feed requirements is summarized in Table 1 below. In this embodiment, the net energy for gain (NEg), and Net energy for maintenance (NEm) concentration of the diet are determined utilizing the Cornell Net Carbohydrate and Protein System (CNCPS).

TABLE 1
Equations to predict individual dry matter requirements

| | |
|---|---|
| (1) | EBW = 1.316 HCW + 32.29 |
| (2) | EBF, % = 17.76207 + 4.68142 FT + 0.01945 HCW + 0.81855 QG − |
| | 0.06754 LMA |
| (3) | AFSBW = (EBW + ((28 − EBF %) × 14.26))/0.891 |
| (4) | EQSBW = SBW × (478/AFSBW) |
| (5) | RE = 0.0635 × EQEBW^{0.75} × EBG^{1.097}; EQEBW = 0.891 × |
| | EQSBW; EBG = 0.956 × ADG |
| (6) | FFG = RE/diet NEg |
| (7) | FFM = NEm required/diet NEm |
| (8) | Individual DM required is FFM + FFG |
| (9) | Adjusted individual DM required = individual DM required × |
| | (total actual pen DM consumed/pen summary of individual DM |
| | required) |

Where EBW=empty body weight; EBF=empty body fat; FT=fat thickness (cm); HCW=hot carcass weight; QG=quality grade; LMA=Longissimus dorsi muscle area (cm²); SBW=shrunk body weight; AFSBW=weight at 28% body fat; EQSBW or EQEBW=shrunk or empty body weight equivalent to the standard reference animal; EBG=empty body gain; RE=retained energy, Mcal/day; FFM=feed for maintenance; FFG=feed for gain; and DM=dry matter.

The NEm required can be obtained by 0.077/EBW^{0.75} adjusted for breed effects, as given in the NRC report on Nutrient Requirements for Beef Cattle, 2000. Environmental effects can also be accounted for by additional terms (see NRC report on Nutrient Requirements for Beef Cattle, 2000). Equation 2 in Table 1 enables predicting EBF percentage from carcass measurements commonly taken in U.S. packing plants. Ultrasound can be used to obtain the required fat depth, rib eye area, and marbling values.

A sample calculation, utilizing the embodiment shown Table 1, is shown in Table 2 below, wherein an indicator of Feed efficiency is the feed/gain ratio defined as the ratio of

TABLE 2
Sample calculation

| Inputs | R sults |
|---|---|
| Initial shrunk weight = 713 lb | Daily gain = 4.64 lb |
| Final shrunk weight = 1265 lb | 28% fat weight = 1241 lb |
| Days on feed = 119 | Net energy for gain = 10.82 |
| | Mcal/day |
| Hot carcass weight = 803 lb | Feed DM for gain = 17.64 |
| | lb/day |
| Quality grade = 5.0 | Net energy for maintenance = |
| | 6.83 lb/day |
| Rib eye area = 79.4 cm2 | Feed DM for maintenance = |
| | 7.49 lb/day |
| Backfat depth = 1.5 cm | Total feed DM required = |
| | 25.16 lb/day |
| Diet NEm = 0.91 | Feed efficiency = 5.42 |
| Diet NEg = 0.61 Mcal/lb | |

the Total daily feed DM required to the Daily (weight) gain (Total daily feed DM required/Daily gain). The feed to gain ratio is an inverse indicator of feed efficiency. That is, as the feed to gain ratio decreases the feed efficiency improves.

In one embodiment, the method of this invention contains a model that utilizes the maintenance and growth and feed energy models described previously along with a feed intake model to predict daily gain, body weight, and feed required on a daily basis as an animal grows to their target final weight. This embodiment of the method of this invention enables the computation of daily energy requirements, DMI, and body weight, and the computation of the predicted feed required during a common stage of growth (from 60 to 80% of mature or finished weight) for each animal allows us to compare animal performance, accommodating the wide range of post-weaning feeding programs under which progeny are evaluated.

Within this embodiment is a model that predicts DMI and ADG for each day while on feed. The predicted DMI is iterated until predicted and observed ADG of that period match (Model 2 of FIG. 1). The predicted DMI is internally interpolated using the relative DMI (RDMI) factor. Then feed required is computed from 70 to 100% of their 28% fat weight. Table 3 summarizes the sequence of calculations in the model used to predict days required to achieve a target composition.

TABLE 3
Sequence of calculations in the model
Step Description

| | |
|---|---|
| 1) | Determine NEm and NEg concentration of the diet using |
| | the CNCPS model structure |
| 2) | Determine the expected shrunk body weight (SBW) at 28% |
| | body fat (Choice AFSBW) |
| 3) | Predict daily DMI based on current SBW, diet energy, |
| | environmental conditions, and Choice AFSBW |
| 4) | Predict feed required for maintenance (FFM, kg) based on |
| | current SBW and environmental conditions as follows: |
| | FFM = NEm required/diet NEm; |
| 5) | Predict NE available for gain (NEFG, Mcal) from DMI and |
| | diet NEg; NEFG = (DMI − FFM) × diet NEg |
| 6) | Predict daily Shrunk Weight Gain (SWG) from NEFG and the |
| | current SEW equivalent to the standard reference animal |
| | (EQSBW) |
| 7) | Compute the new SEW of the animal by adding SWG in step |
| | 6 to the initial SBW |
| 8) | Repeat steps 5 to 9 for each additional day until animal |
| | reaches actual finished SBW |
| 9) | Adjust predicted DMI until actual and predicted ADG match |
| 10) | Compute body weight at 70 and 100% of 28% fat weight |
| 11) | Predict ADG and feed required for the growth period |
| | between 70 and 100% of 28% fat weight. |

The following additional quantities of interest can be obtained: carcass weight, feed cost of gain. The carcass weight is obtained, in one embodiment, by:

a) obtaining the equivalent carcass weight (EQCW)=(EQEBW−30.3)/1.36,

b) obtaining the carcass weight proportion (CWP)=EQCW/EQSW, and,

c) obtaining the carcass weight (CW)=CWP×SBW.

The improvement in feed cost (savings in feed cost) is obtained by comparing the feed cost (cost/lb times the pounds of feed required) between contemporaries fed under the same conditions.

Reference is now made to the following illustrative example of the application of the above embodiment of the present invention.

Data from the New York State Bull test conducted from Dec. 16, 2000 to Apr. 7, 2001 with 93 bulls are used to demonstrate how the above described embodiment of the method of this invention is used to predict feed efficiency for individual bulls being evaluated. The diet ingredients were analyze for NDF, lignin, crude protein, soluble protein, and cell wall-bound protein for use in the CNCPS model to predict the diet energy content (ME of 1.25 Mcal/lb DM). The diet formula and CNCPS ME value were entered into a program implementing the above described embodiment of the method of this invention. Each individual animals' information (initial and final body weight, hip height and age, and ultrasound fat depth, rib eye area (LMA), and marbling, and body weight at the time of ultrasound) was also entered as input to the program. Empty body weight (EBW) was computed from shrunk body weight (SBW) multiplied by 0.891 and hot carcass weight (HCW) was computed from EBW using a computer code implementing equation (1) in Table 1 (Table 1 equations are from Guiroy, P. J., Fox, D. G., Tedeschi, L. O., Baker, M. J., Cravey, M. D. “Predicting individual feed requirements of cattle fed in groups”, Journal of Animal Science, volume 79 pages 1983-1995, August 2001). (This embodiment of the method of this invention has been implemented in an object oriented computer code.) Hip height and age were used to compute frame score and 28% fat weight, and the ultrasound information was used to predict 28% fat weight using steps 2 and 3 in Table 1. The model described in Table 3 was then used to compute the feed required for each animal over the actual feeding period and during the same stage of growth.

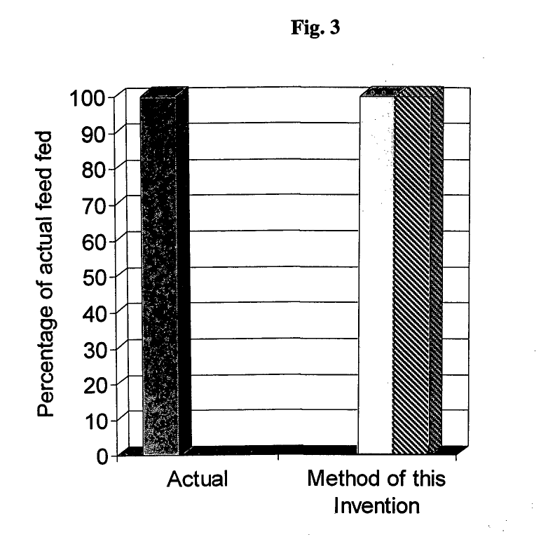

Before computing individual feed efficiencies and cost of gain, it is determined whether the sum of individual feed requirements agree with the total of the feed actually fed over the feeding period. This provides a check on the accuracy of the inputs (diet energy values, and animal inputs and measurements), and how well the model is working in this situation. FIG. 3 shows the percentage of the total actual feed DM consumed by all bulls that was predicted by the sum of the individual bull predicted feed required for the observed ADG.

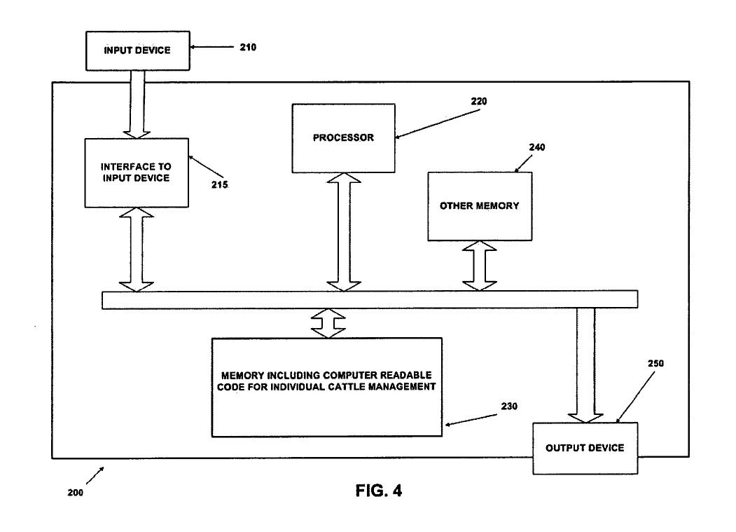

A block diagram representation of an embodiment of the system 200 that implements the method of this invention is shown in FIG. 4. Referring to FIG. 4, the system 200 includes an input device 210 providing inputs for computation, one or more processors 220, and one or more computer readable memories 230, and one or more output devices 240. The one or more computer readable memories have computer readable code embodied therein, which is capable of causing the at least one processor to execute the above described method of this invention. The interface component 215 receives the input data from the input device 310 and provides the input data to the computer readable memories 330, 340. The computer readable memory 340 provides memory for other operational tasks. The results from the method of this invention are displayed by means of the output devices 240.

It should be noted that although the system 200 is shown as one physical unit, the system 200 may also include means for remote access and/or distributed processing, such as modems or direct connection to a network (not shown). In that embodiment, the computer readable code may include a component such as an applet and/or remote components in a distributed architecture.

It should be noted that although a detailed illustrative embodiment is disclosed above, other detailed embodiments including improvements to the detailed equations are also within the scope of this invention.

In general, the techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to data entered using the input device to perform the functions described and to generate output information. Input device, as used herein, refers to any device, such as, but not limited to, a keyboard, a mouse, voice input, a touch sensitive pad or display, a computer pen, or a writing tablet, that is used to provide input data to provide data to a programmable computer. The output information may be applied to one or more output devices. Output device, as used herein, refers to any device, such as, but not limited to, printers, monitor or the other display device, sound output, computer readable media, electrical signals, means for transmitting data or providing data to data networks, or other means of displaying output data.

Each computer program within the scope of the claims below may be implemented in any programming language, such as, but not limited to, assembly language, machine language, a high-level procedural programming language (BASIC, C, C++, C#, Pascal, Fortran), an object-oriented programming language, or a database programming language. The programming language may be a compiled or interpreted programming language.

Each computer program may be implemented in a computer program product tangibly embodied in a computer-readable storage device for execution by a computer processor. Method steps of the invention may be performed by a computer processor executing a program tangibly embodied on a computer-readable medium to perform functions of the invention by operating on input and generating output.

Common forms of computer-readable or usable media include, for example, a floppy disk, a flexible disk, hard disk, magnetic tape, or any other magnetic medium, a CD-ROM, a DVD-ROM, any other optical medium, punched cards, paper tape, any other physical medium with patterns of holes, a RAM, a PROM, and EPROM, a FLASH-EPROM, any other memory chip or cartridge, a carrier wave, or any other medium from which a computer can read.

Although the invention has been described with respect to various embodiments, it should be realized this invention is also capable of a wide variety of further and other embodiments within the spirit and scope of the appended claims.

What is claimed is:

1. A method for managing the individual feeding of cattle, the method comprising the step of:
(a) predicting a daily feed requirement for an individual animal taking into account genotype, diet, and environmental differences; and,
(b) predicting a daily weight gain of the individual animal.

2. The method of claim 1 further comprising the step of:
repeating steps (a) and (b) until a target finished body weight is substantially reached.

3. The method of claim 2 further comprising the step of:
predicting number of days to achieve a target finished body weight for the individual animal taking into account genotype and environmental differences.

4. The method of claim 3 further comprising the step of:
predicting performance information for the individual animal taking into account genotype and environmental differences;
wherein the performance information comprises feed intake, and feed efficiency.

5. The method of claim 1 further comprising the step of:
predicting carcass weight from the finished weight.

6. The method of claim 1 further comprising the step of:
predicting daily and accumulated feed cost.

7. The method of claim 1 further comprising the step of:
adjusting the predicted daily feed requirement until predicted daily gain substantially equals actual daily gain.

8. The method of claim 1 wherein the step of predicting the daily feed requirement for the individual animal further comprises the steps of:
calculating an empty body fat percentage for the individual animal taking into account individual animal characteristics; and
calculating an adjusted shrunk body weight of the individual animal.

9. A system for managing the individual feeding of cattle, the system comprising:
at least one processor; and,
at least one computer readable memory having computer readable code embodied therein, the computer readable code capable of causing the at least one processor to:
obtain the daily feed requirement for an individual animal taking into account genotype and environmental differences, and
obtain a daily weight gain of the individual animal;
input means for providing input data to the at least one processor;
output means for obtaining output data from the at least one processor.

10. The system of claim 9 wherein the computer readable code is further capable of causing the at least one processor to:
repeatedly obtain the daily feed requirement for an individual animal taking into account genotype, diet, and environmental differences, and the daily weight gain until a finished weight is reached.

11. The system of claim 10 wherein the computer readable code is further capable of causing the at least one processor to:
predict number of days to achieve a target finished body weight for the individual animal taking into account genotype and environmental differences.

12. The system of claim 11 wherein the computer readable code is further capable of causing the at least one processor to:
predict performance information for the individual animal taking into account genotype and environmental differences;
wherein the performance information comprises feed intake, and feed efficiency.

13. The system of claim 9 wherein the computer readable code is further capable of causing the at least one processor to:
predict carcass weight from the finished weight.

14. The system of claim 8 wherein the computer readable code is further capable of causing the at least one processor to:
predict saving in feed cost.

15. The system of claim 8 further comprising:
means for remote access and distributed processing.

16. A computer program product comprising:
a computer usable medium having computer readable code embodied therein, the computer readable code capable of causing a computer system to:
obtain a daily feed requirement for an individual animal taking into account genotype and environmental differences; and,
obtain a daily weight gain of the individual animal.

17. The computer program product of claim 16 wherein the computer readable code is further capable of causing the computer system to:
repeatedly obtain the daily feed requirement for an individual animal taking into account genotype, diet, and environmental differences, and predicting a daily weight gain until a finished weight is reached.

18. The computer program product of claim 17 wherein the computer readable code is further capable of causing the computer system to:
predict number of days to achieve a target finished body weight for the individual animal taking into account genotype and environmental differences.

19. The computer program product of claim 18 wherein the computer readable code is further capable of causing the computer system to:
predict performance information for the individual animal taking into account genotype and environmental differences;
wherein the performance information comprises feed intake, and feed efficiency.

20. The computer program product of claim 18 wherein the computer readable code is further capable of causing the computer system to:
predict carcass weight from the finished body weight.

21. The computer program product of claim 16 wherein the computer readable code is further capable of causing the computer system to:
predict saving in feed amount and cost.

22. A system for managing the individual feeding of cattle comprising:
means for predicting a daily feed requirement for an individual animal taking into account genotype, diet, and environmental differences; and,
means for predicting a daily weight gain for the individual animal.

23. The system of claim 22 further comprising:
means for repeatedly predicting the daily feed requirement for an individual animal taking into account genotype, diet, and environmental differences, and the daily weight gain until a finished body weight is reached.

24. The system of claim 23 further comprising:
means for predicting number of days to achieve a target finished body weight for the individual animal taking into account genotype and environmental differences;

25. The system of claim 24 further comprising:
means for predicting performance information for the individual animal taking into account genotype and environmental differences;
wherein the performance information comprises feed intake, and feed efficiency.

26. The system of claim 22 further comprising:
means for adjusting the predicted daily feed requirement until predicted daily gain substantially equals actual daily gain.

27. The system of claim 22 further comprising:
means for predicting daily and accumulated feed cost.
